(19) United States
(12) Patent Application Publication
(10) Pub. No.: US 2024/0088680 A1
(43) Pub. Date: Mar. 14, 2024

(54) Battery Charging Control Device and Battery Charging Control Method

(71) Applicant: Andreas Stihl AG & Co. KG, Waiblingen (DE)

(72) Inventors: Hyun Young KIM, Stuttgart (DE); Fabian FRECH, Hattenhofen (DE); Maximilian WEICHERT, Remseck (DE); Christian SPINDLER, Stuttgart (DE)

(21) Appl. No.: 18/367,774

(22) Filed: Sep. 13, 2023

(30) Foreign Application Priority Data
Sep. 13, 2022 (EP) 22195413.4

(51) Int. Cl. H02J 7/00

(52) U.S. Cl. CPC H02J 7/0029; H02J 7/0013; H02J 7/0047; H02J 7/00712

(57) ABSTRACT

A battery charging control device controls charging operations of rechargeable battery units, for which electrical energy is provided by an electrical energy source. The battery charging control device includes a charging control unit having an input connection capable of being coupled to the energy source for supplying an energy supply signal, and an output connection configuration with one or more parallel output connections for coupling a charger arrangement which comprises one or more chargers each having one or more charging ports for the rechargeable battery units. The charging control unit is configured to monitor the current provided by the energy source at the input connection and/or a current provided at a respective output connection and to enable the activation of a charging operation at a respective charging port.

### CROSS REFERENCE TO RELATED APPLICATION

This application claims priority under 35 U.S.C. § 119 from European Patent Application No. 22195413.4, filed Sep. 13, 2022, the entire disclosure of which is herein expressly incorporated by reference.

### BACKGROUND AND SUMMARY

The present subject matter relates to a battery charging control device for controlling charging operations of rechargeable battery units, for which electrical energy is provided by an electrical energy source. The battery charging control device comprises a charging control unit having an input connection capable of being coupled to the energy source for supplying an energy supply signal, and an output connection configuration with one or more, in particular electrically parallel, output connections for coupling a charger arrangement which comprises one or more chargers each having one or more charging ports for the rechargeable battery units. The present subject matter also relates to a corresponding battery charging control method.

Battery charging control devices and battery charging control methods of this type are variously known and are preferably used to electrically charge a plurality of battery units with electrical energy from the energy source in a controllable manner. The battery units can be of the same or different design or the same or different type and can be realized, for example, as so-called rechargeable battery packs, as are usually used to supply energy to various electrically driven devices. These devices can be, for example, hand-guided implements, such as hand-held or ground-guided implements or working devices in the construction and DIY sector, in horticulture and forestry. To do this, the chargers have charging ports where the battery units to be charged can be positioned and charged. Each charger can have one or more charging ports, and a single charger or a cascade of successive chargers can be coupled to the output side of the charging control unit for each output connection, depending on the requirements and application.

In particular, in the case of a plurality of chargers or a plurality of charging ports, there is a desire to be able to carry out simultaneous or temporally overlapping charging operations at the charging ports in such a way that, on the one hand, the energy supply capacity of the electrical energy source is used in the best possible way and thus the total charging times are minimized without, on the other hand, the energy source or the electrical line for carrying the energy supply signal being overloaded. The electrical energy source can be, in particular, a public electricity grid or self-sufficient, decentralized energy producers, such as, inter alia, fuel cells and generators, as well as renewable energy producers in the form of wind turbines, photovoltaic systems and hydropower plants.

Laid-open publication EP 2 909 911 A1 discloses a method and an apparatus for transmitting electrical power between an energy supply grid and an energy consumer, such as a traction battery of an electric vehicle, or an energy producer, such as a photovoltaic or wind power inverter, where an overload or oversupply of the energy supply grid is determined by a slight deviation of the grid frequency from a nominal frequency, such as a deviation of approximately 0.2 Hz to 0.5 Hz from a nominal frequency of 50 Hz, and depending on this, the power transmission is changed.

Laid-open publication EP 2 589 277 A1 discloses a current load management system for charging batteries, in which a plurality of electrical loads, such as rechargeable batteries, are iteratively divided into groups in such a way that a sum of measured currents of the loads in each group does not exceed a specified current limit, wherein the current limit is determined by coupling a current sensor to an unswitched energy output of the system that is specifically used for this purpose.

It is an object of the present subject matter to provide a battery charging control device and a battery charging control method of the type mentioned at the outset, which offer further improvements compared to the above-mentioned prior art, in particular with regard to further optimized control of the preferably multiple and possibly simultaneously occurring or temporally overlapping charging operations at the preferably multiple charging ports.

The present subject matter achieves this and other objects by providing a specific battery charging control device and a related battery charging control method. Advantageous developments of the present subject matter are specified in the dependent claims, the wording of which is hereby incorporated by reference into the description. This also includes, in particular, all examples of the present subject matter resulting from the combinations of features defined by the back-references in the dependent claims.

As already mentioned at the outset, the charging control unit of the battery charging control device according to the present subject matter has an input connection, which can be coupled to the energy source and is intended to supply an energy supply signal, and an output connection configuration with one or preferably more, i.e. two, three, four or more, output connections for coupling a charger arrangement which comprises one or more chargers each with one or more charging ports for the rechargeable battery units, wherein they may be in particular electrically parallel output connections.

According to a first aspect of the present subject matter, the charging control unit is configured to detect a maximum current load state of an electrical current overload protection system of the energy source and, if the maximum current load state of the current overload protection system is detected, to control the current carried by the energy supply signal from the energy source via the current overload protection system to ensure that the detected maximum current load state of the current overload protection system is complied with.

This aspect of the present subject matter is naturally suitable for coupling the battery charging control device to an energy source which is equipped with a corresponding current overload protection system on the output side. This can be, for example, a circuit breaker, such as the A, B and C type used for protecting house connections in public power grids. Means and methods for detecting the maximum current load state of electrical current overload protection systems are variously familiar to a skilled person, depending on the type of current overload protection system. Since the device is able to detect the maximum current load state itself, this information does not have to be supplied to it, which is also particularly advantageous when using the battery charging control device at different energy sources with different maximum current load states.

According to a second aspect of the present subject matter, which may be provided in addition or as an alternative to the above-mentioned first aspect in corresponding examples of the present subject matter, the charging control unit is configured to monitor the current provided by the energy source at the input connection and/or a current provided at a respective output connection and to enable the activation of a charging operation at a respective charging port if the current provided by the energy source and/or the current provided by the charging control unit at the relevant output connection does not exceed an associated predefinable lower current threshold value, and/or to reduce a current provided for a charging operation at a respective charging port if the current provided by the energy source and/or the current provided by the charging control unit at the relevant output connection exceeds an associated predefinable upper current threshold value. Depending on the implementation, the current reduction can involve simply reducing the current to a current intensity value above zero or deactivating the charging operation, i.e. reducing the current to zero.

This allows charging operations to be optimized in such a way that they are activated as long as the associated input-side and/or output-side current intensity does not exceed the lower current threshold value which can be suitably predefined for this purpose and indicates that there are still current reserves and/or that their charging current is reduced or they are completely deactivated as soon as the relevant current intensity exceeds the upper current threshold value, which represents an overload situation, for which the upper current threshold value can be suitably predefined.

In a corresponding implementation of the present subject matter, the lower current threshold value can be predefined on the basis of the upper current threshold value, preferably less than the upper current threshold value. In particular, the lower current threshold value at the beginning of a charging sequence, such as at the time of coupling to the energy source, may be predefined to be at least 2 A and at most 4 A less than the upper current threshold value.

In a development of the present subject matter, the charging control unit is configured to determine a signal strength of a frequency component of an AC voltage and/or an alternating current of the energy supply signal from the energy source in a predefinable monitoring frequency range and to detect the presence of the maximum current load state of the current overload protection system if the signal strength is above a normal signal strength by a predefinable amount, wherein the monitoring frequency range is above 10 kHz, in particular above 25 kHz and/or below 150 kHz. The predefinable amount of signal strength increase in the specified frequency range can be, for example, approximately 3 dB.

Detecting the maximum current load state of the current overload protection system in this way is particularly suitable for cases in which the current overload protection system, as already mentioned above, consists of a circuit breaker, e.g. of the A, B or C type. This is because these circuit breakers exhibit, as is known per se to a skilled person, an arc-like behaviour of the AC voltage applied across them and/or of the alternating current carried via them when approaching their response point, in which case this behaviour in particular causes a significant signal increase in the said frequency range above 10 kHz, in particular, for example, between 30 kHz and 140 kHz. The device can therefore advantageously use this measure to automatically detect when the current carried via the current overload protection system, in particular but not necessarily exclusively the current used for the charging operations, approaches the load limit of the current overload protection system.

In a development of the present subject matter, the charging control unit is configured to enable one or more charging operations only until the maximum current load state of the current overload protection system is reached. The charging control unit thus ensures that the current overload protection system is not overloaded by activating charging operations.

In a development of the present subject matter, the charging control unit is configured to reduce the lower current threshold value by a predefinable current reduction increment if the current provided by the energy source and/or the current provided by the charging control unit at the relevant output connection exceeds the upper current threshold value. With this design of the charging control unit, hysteresis with respect to the deactivation and reactivation of a relevant charging operation can be provided, which counteracts a usually undesirable rapid cyclical change of activation and deactivation of the charging operation.

In corresponding designs, the charging control unit is configured to reduce the lower current threshold value repeatedly, in particular several times, by a predefinable current reduction increment.

In a refinement of the present subject matter, the current reduction increment can be predefined to a value between 1 A and 5 A, in particular between at least 2 A and at most 4 A. This example is generally well suited, for example, for energy sources that are designed for a maximum continuous current intensity of the order of magnitude of 16 A.

In a refinement of the present subject matter, the charging control unit is configured to raise the lower current threshold value, previously reduced by the predefinable current reduction increment, by a predefinable current increase increment if the current provided by the energy source and/or the current provided by the charging control unit at the relevant output connection does not exceed the upper current threshold value during a predefinable charging monitoring time. With this design of the charging control unit, the lower current threshold value, previously reduced to provide the desired hysteresis with respect to the deactivation and reactivation of a relevant charging operation, can be raised again as soon as this is favorable in the situation. The charging monitoring time is set appropriately to ensure that the charging current no longer rises above the upper current threshold value. Corresponding implementations may provide for an identical charging configuration to be required for this current monitoring, i.e. that the same charging operations are activated via the same output connections, such as at the time at which the lower current threshold value is reduced, i.e. after reactivation of a charging operation at a relevant charging port that was previously deactivated due to the upper current threshold value being exceeded by the current provided by the energy source and/or the current provided by the charging control unit at the relevant output connection.

In a refinement of the present subject matter, the current increase increment can be predefined to a value between 1 A and 5 A, in particular between at least 2 A and at most 4 A, and/or to the same value as the current reduction increment. This example is advantageously adapted to the selection of the current reduction increment, wherein the current increase increment can be selected to be as large as the current reduction increment or less or greater than this, depending on the requirements and application. In particular, the current increase increment can be predefined in such a way that an initial value, determined or predefined at the beginning of a charging sequence, of the lower current threshold value, which has been reduced in the meantime, is reached again.

In corresponding implementations of the present subject matter, instead of or in addition to input-side current detection at the input connection of the charging control unit, output-side current detection at the respective output connection is provided. In these cases, the current increase increment for the relevant output connection can be selected individually according to the detected current provided at this output connection. The lower current threshold value and/or the current increase increment can preferably be selected differently for the different output connections.

In a development of the present subject matter, the charging control unit is configured to detect when the voltage of the energy supply signal undershoots a predefinable minimum voltage setpoint by a predefinable undershoot amount for a predefinable minimum undershoot period and to then lower the upper current threshold value by a predefinable current lowering increment. This detection, preferably executed cyclically repeatedly, is particularly suitable for energy sources with a relatively strongly fluctuating power output and in particular a fluctuating power delivery capacity, as is the case, for example, with wind turbines and photovoltaic systems, and enables optimized power output adjustment.

In a refinement of the present subject matter, the minimum voltage setpoint can be predefined to a value between 206 V and 208 V, in particular to 207 V, and/or the undershoot amount can be predefined to a value between 1 V and 2 V and/or the minimum undershoot period can be predefined to a value between 9 ms and 11 ms, in particular to 10 ms, and/or the current lowering increment can be predefined to a value between 1 A and 4 A, in particular to 2 A. These values are particularly suitable for an energy source with a nominal voltage of 220 V to 230 V.

In a development of the present subject matter, the charging control unit is configured to detect when the voltage of the energy supply signal exceeds a or the predefinable minimum voltage setpoint by a predefinable exceedance amount for a predefinable minimum exceedance period and to then raise the upper current threshold value by a predefinable current raising increment. This detection, preferably executed cyclically repeatedly, is in turn particularly suitable for energy sources with a fluctuating power output and in particular a fluctuating power delivery capacity, as is the case, for example, with wind turbines and photovoltaic systems, and enables optimized power output adjustment by being able to completely or partially reverse any previous reduction in the upper current threshold value again as soon as this no longer leads to an undesired voltage dip.

In a refinement of the present subject matter, the minimum voltage setpoint can be predefined to a value between 206 V and 208 V, in particular to 207 V, and/or the exceedance amount can be predefined to a value between 1 V and 2 V and/or the minimum exceedance period can be predefined to a value between 9 ms and 11 ms, in particular to 10 ms, and/or the current raising increment can be predefined to a value between 1 A and 4 A, in particular to 2 A. As explained above, in this case too, these values are particularly suitable for an energy source with a nominal voltage of 220 V-240 V, e.g. 230 V.

In a development of the present subject matter, the charging control unit has charging prioritization information, on the basis of which it initiates the activation of a respective charging operation, wherein the charging prioritization information comprises output connection priority information and/or charging port priority information and/or state of charge priority information and/or charging specification priority information. The output connection priority information stipulates the priority for activating a charging operation via the respective output connection of the charging control unit. In a corresponding example, the output connection priority information is in particular dependent on charging specifications which are stored in the battery unit and are predefined by a user via a corresponding interface, for example a smartphone. The charging port priority information stipulates the priority for activating a charging operation at the respective charging port of the charging control unit. The state of charge priority information stipulates the priority for activating a charging operation for a battery unit arranged in a charging port and having an associated state of charge, e.g. a higher priority for a battery unit with a lower state of charge compared with a battery unit with a higher state of charge at another charging port. The charging specification priority information stipulates the priority for activating a charging operation for a battery unit arranged at a charging port, depending on a charging specification available for this charging port or this battery unit, e.g. a higher priority for a battery unit that is required in a short time and therefore should be charged quickly.

The charging control unit prioritizes the charging operation depending on the charging specifications that have been stored in the battery unit by the user.

The battery charging control method according to the present subject matter can be carried out in particular by the battery charging control device according to the present subject matter and has the corresponding advantages and effects of the battery charging control device according to the present subject matter, as explained above.

Other objects, advantages and novel features of the present subject matter will become apparent from the following detailed description of one or more preferred examples when considered in conjunction with the accompanying drawings.

### BRIEF DESCRIPTION OF THE DRAWINGS

FIG. 1 shows a schematic block diagram illustration of a battery charging control device having a charging control unit with current measurement on the input side only;

FIG. 2 shows a schematic block diagram illustration of a battery charging control device having a charging control unit with current measurement on the input side and on the output side;

FIG. 3 shows a signal strength/frequency graph for illustrating detection of a maximum current load state of a current overload protection system;

FIG. 4 shows a schematic block diagram of a part of the charging control unit for detecting the maximum current load state of the current overload protection system;

FIG. 5 shows a current intensity/time graph for illustrating a charging sequence of the charging control unit;

FIG. 6 shows a current intensity/time graph for illustrating a charging sequence of the charging control unit with an upper current threshold value being exceeded;

FIG. 7 shows a current intensity/time graph for illustrating a charging sequence of the charging control unit with a lower current threshold value being lowered and raised again; and

FIG. 8 shows a flowchart for illustrating adjustment of an upper current threshold value to a fluctuating supply voltage by the charging control unit.

### DETAILED DESCRIPTION

In the figures, the battery charging control device is illustrated in various examples and with different implemented functionalities. The battery charging control device is used to control electrical charging operations of electrically rechargeable battery units, for which electrical energy is provided by an electrical energy source. The battery units can be any electrically rechargeable battery units of a conventional type, for example rechargeable battery packs for supplying energy to battery-operated, hand-held or ground-guided implements and working devices in the construction and DIY sector, in horticulture and forestry. The electrical energy required for the charging operations is normally provided by the electrical energy source which may be in particular a public electricity grid or a self-sufficient, decentralized energy producer, such as a fuel cell system, a generator, a wind turbine, a photovoltaic system or a hydropower plant.

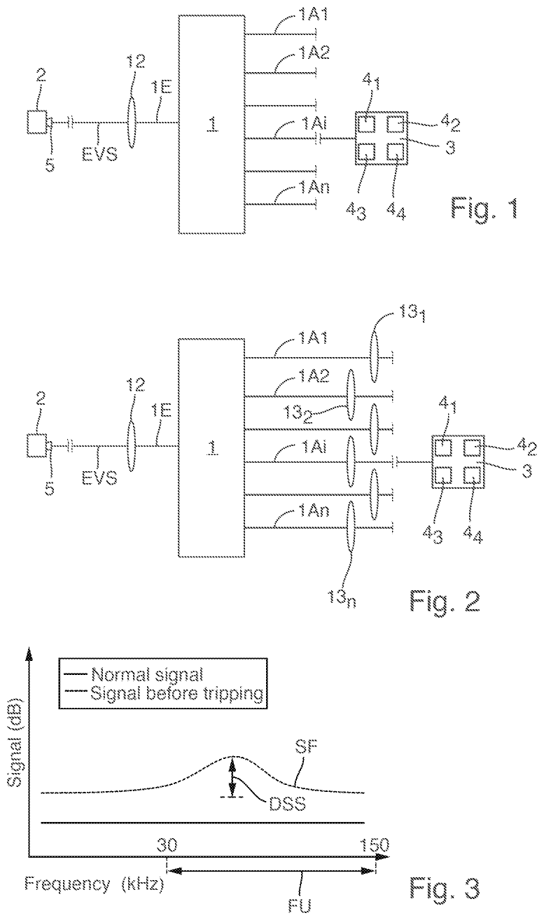

As can be seen in FIGS. 1 and 2, the battery charging control device comprises a charging control unit 1 having an input connection 1E which can be coupled to the energy source and is intended to supply an energy supply signal EVS. For illustration, this coupling of the input connection 1E of the charging control unit 1 to an energy source 2 is schematically indicated in FIGS. 1 and 2, which energy source can be of any of the energy source types mentioned and provides the energy supply signal EVS. It is understood that, depending on the requirements and application, the charging control unit 1 can also be coupled to one or more additional energy sources via the aforementioned input connection 1E and/or can have one or more further input connections for coupling to one or more further energy sources.

On the output side, the charging control unit 1 has an output connection configuration with one or more, preferably electrically parallel, output connections for coupling a charger arrangement. FIGS. 1 and 2 illustrate an example of the charging control unit 1 having a number n of such output connections 1A1, 1A2, . . . , 1An, with n as any natural number greater than or equal to one. The charger arrangement comprises, in a customary manner that is therefore not shown any further here and does not need to be explained any further here, one or more chargers each with one or more charging ports for the rechargeable battery units. Such chargers are known in various examples, e.g. in the form of single chargers with only one charging port for a rechargeable battery pack that can be placed there for charging, or in the form of multiple chargers with a plurality of such rechargeable battery pack charging ports which, depending on the example and requirements, can be supplied with charging current by the charger at the same time or sequentially in order to carry out corresponding charging operations.

It is understood that, depending on the requirements and system design, a single charger or a plurality of chargers can be coupled in parallel and/or cascaded in series to the respective j-th output connection 1Aj, 1≤j≤n. FIGS. 1 and 2 illustrate, merely by way of example and representatively, the coupling of a charger 3 with four rechargeable battery pack charging ports 4₁, 4₂, 4₃, 4₄ to an i-th output connection 1Ai of the charging control unit 1. It should be mentioned at this point that the battery charging control device is also particularly suitable for applications in which the charger arrangement comprises a relatively large number of chargers, be it single chargers each with one charging port and/or multiple chargers each with a plurality of charging ports. The charger arrangement can be located, for example, in a workshop or another stationary environment in which battery-operated devices are used, or alternatively in a mobile environment, such as a transport vehicle or the like, in order to be able to charge a correspondingly large number of battery units at the same time, if necessary.

A basic idea of the battery charging control device is to control the charging operations in such a way that as many required charging operations as possible can be carried out at any time and/or the respective charging operations can be carried out with as optimally high a charging power as possible, without undesired current overload effects occurring, such as an excessive current load on the electrical line supplying the energy supply signal EVS.

It is understood that, if required, a plurality of copies of the battery charging control apparatus or of its charging control units 1 may be components of a higher-level, data-networked battery charging system which, in addition to the plurality of battery charging control devices or charging control units 1, comprises, for example, a cloud backend, for example with databases, one or more front-end units which are configured for access by means of conventional user terminals and are communicatively connected to the backend, as well as user-side terminals, such as smartphones, which are likewise communicatively connected to the backend. The battery charging control devices or charging control units 1 are communicatively connected to the backend via a suitable intermediate station, such as a gateway or a WLAN router. A plurality of intermediate stations can also be provided in this case, and the respective intermediate station can also be designed for short-range communication, e.g. via Bluetooth, if required.

In an advantageous example, the charging control unit 1 is configured to detect a maximum current load state of an electrical current overload protection system of the energy source and, if the maximum current load state of the current overload protection system is detected, to control the current carried by the energy supply signal EVS from the energy source via the current overload protection system to ensure that the maximum current load state of the current overload protection system is complied with. For illustration purposes only, such an electrical current overload protection system 5 is schematically indicated in FIGS. 1 and 2 and is used to conduct the energy supply signal EVS. The current overload protection system can be of a conventional type in this case, in particular a circuit breaker of the A, B or C type, as is common, for example, with a maximum current carrying capacity in the range of 12 A to 20 A. It should be mentioned at this point that, as usual, the term current is also used synonymously with the term current intensity in the present case.

In advantageous examples, the charging control unit 1 is configured to determine a signal strength SF of a frequency component of an AC voltage and/or an alternating current of the energy supply signal EVS from the energy source in a predefinable monitoring frequency range FU and to detect the presence of the maximum current load state of the current overload protection system if the signal strength SF is above a normal signal strength by a predefinable amount DSS, wherein the monitoring frequency range FU is above 10 kHz. FIG. 3 illustrates this functionality of the charging control unit 1 in this implementation. Specifically, the monitoring frequency range FU in this example is above 25 kHz and/or below 150 kHz, e.g. between approx. 30 kHz and approx. 140 kHz. The predefinable excess DSS in signal strength can be, for example, in the range of 3 dB to 12 dB, such as approx. 3 dB or between 6 dB and 8 dB.

This system design is particularly suitable for detecting the maximum current load state of the current overload protection system, if the latter is a circuit breaker. This is because such current overload protection systems usually have the property that they exhibit an arc-like behavior when approaching their maximum current load state, which behavior has, among other things, the effect that the signal strength SF of the frequency component of the AC voltage and/or the alternating current of the energy supply signal EVS in the said monitoring frequency range FU increases significantly, which is expressed in the frequency spectrum of the AC voltage and/or the alternating current in this frequency range forming the said exceedance amount DSS. It is understood that there may also be a corresponding increase in signal strength in the frequency range of associated harmonics.

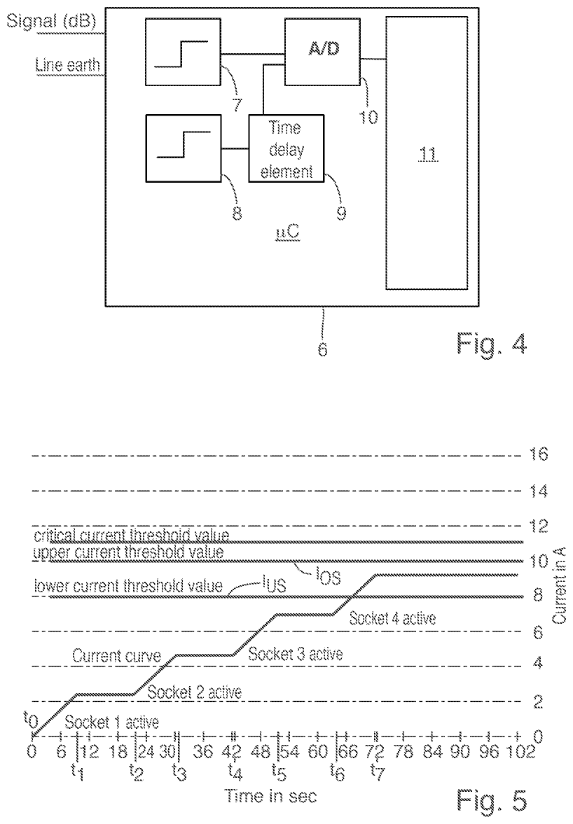

FIG. 4 schematically illustrates a possible implementation of a part 6 of the charging control unit 1, with which it is able to carry out the aforementioned detection of the maximum current load state of the current overload protection system. For this purpose, this part 6 of the charging control unit 1 has, as shown, a connection each for a line earth and for the frequency signal to be detected according to FIG. 3, a signal increasing unit 7, a signal average value unit 8, a time delay unit 9, an analogue/digital converter 10 and a digital part 11. The signal increasing unit 7 detects a signal increase by the predefinable amount DSS, and the analog/digital converter 10 compares the input signal supplied to it by the signal increasing unit 7 with a signal average value supplied by the units 8 and 9 and outputs a corresponding output signal to the digital part 11 which is then used to output whether or not the signal strength SF in the relevant frequency range FU has increased by the predefinable amount DSS and therefore the maximum current load state of the current overload protection system is present. As also indicated in FIG. 4, this part 6 of the charging control unit 1 can be realized, for example, by a microprocessor unit or implemented in software and/or hardware in the latter.

Expediently, the charging control unit 1 is further configured to enable one or more charging operations only until it is detected that the maximum current load state of the current overload protection system has been reached. As soon as the charging control unit 1 detects that the current overload protection system threatens to reach or exceed its maximum current load state, the charging control unit 1 does not activate a further charging operation and/or deactivates one or more ongoing charging operations, thereby preventing the current overload protection system from responding and interrupting the supply of the energy supply signal EVS from the energy source to the charging control unit 1.

In advantageous examples, the charging control unit 1 is configured to monitor the current provided by the energy source at the input connection 1E and/or a current provided at a respective one of the output connection(s) 1A1, . . . , 1An and to enable the activation of a charging operation at a respective charging port if the current provided by the energy source and/or the current provided by the charging control unit 1 at the relevant output connection 1A1, . . . , 1An does not exceed an associated predefinable lower current threshold value IUS, and/or to deactivate a charging operation at a respective charging port or to reduce the charging current intensity thereof if the current provided by the energy source and/or the current provided by the charging control unit 1 at the relevant output connection 1A1, . . . , 1An exceeds an associated predefinable upper current threshold value IOS. Preferably, the charging control unit enables the activation of the charging operation at the respective charging port only if the current provided by the energy source and/or the current provided by the charging control unit 1 at the relevant output connection 1A1, . . . , 1An does not exceed the associated predefined lower current threshold value IUS.

The specific design of the charging control unit 1 in this regard depends, among other things, on which current measurement functionality is implemented for the battery charging control device. Thus, FIG. 1 shows an example with current measurement on the input side only, schematically illustrated in FIG. 1 by an input-side current measurement unit 12. FIG. 2 shows an example in which, in addition to the current measurement on the input side, a current measurement on the output side is also individually implemented for each output connection 1A1, . . . , 1An, illustrated in FIG. 2 by a respective current measurement unit 131 to 13n. In further examples not shown, the current measurement of the charging control unit 1 is only implemented on the output side, i.e. at the respective output connection 1A1, . . . , 1An. The current measurement on the input side is preferably realized as a measurement of the absolute current, i.e. the active power current, if, as in most cases, the energy supply signal EVS is an AC voltage/alternating current signal, e.g. an AC voltage/alternating current signal of a public electricity grid with a nominal voltage of 230 V and a frequency of 50 Hz.

The variant with current measurement on the output side requires more effort than the current measurement on the input side, especially with a relatively large number n of output connections 1A1, . . . , 1An, but enables more flexible adaptation of the charging operations to the respective power supply situation.

FIG. 5 illustrates a charging sequence, as can be carried out by the charging control unit 1 in a corresponding implementation, wherein this can refer in particular to an example with current measurement on the input side. At a time to, the charging control unit 1 activates a charging operation for a first (socket 1) of the output connections 1A1, . . . , 1An, wherein the relevant output connection 1A1, . . . , 1An is also referred to here and hereinafter as a socket, i.e. the respective battery unit is positioned, for example in the case of the coupling of single chargers for charging, at a charging port of that charger which is coupled to this output connection. The charging current, and thus the current supplied to the charging control unit 1 at the input connection 1E on the input side, increases up to a time t₁, from which it then initially remains constant. At a time t₂, the charging control unit 1 additionally activates a charging operation at a second (socket 2) of the output connections 1A1, . . . , 1An. The current curve for the current supplied at the input connection 1E of the charging control unit 1 in turn increases up to a time t₃, in order to then remain constant again. At a time t₄, the charging control unit 1 additionally activates a third charging operation at a third (socket 3) of the output connections 1A1, . . . , 1An, with the result that the input-side current increases again up to a time t₅ and then remains constant. At a time t₆, the charging control unit 1 additionally activates a fourth charging operation at a fourth (socket 4) of the output connections 1A1, . . . , 1An, with the result that the input current increases again up to a time t₇, in order to then remain constant again.

As can be seen from FIG. 5, the current measured on the input side exceeds the associated predefined lower current threshold value IUS as the charging current for the fourth charging operation increases. As a result, the charging control unit 1 no longer enables activation of a further charging operation as long as the current provided by the energy source has not fallen below the lower current threshold value IUS again. In this case, the optimum of four simultaneous charging operations is achieved and the current provided by the energy source for this is between the lower current threshold value IUS and the associated predefined upper current threshold value IOS.

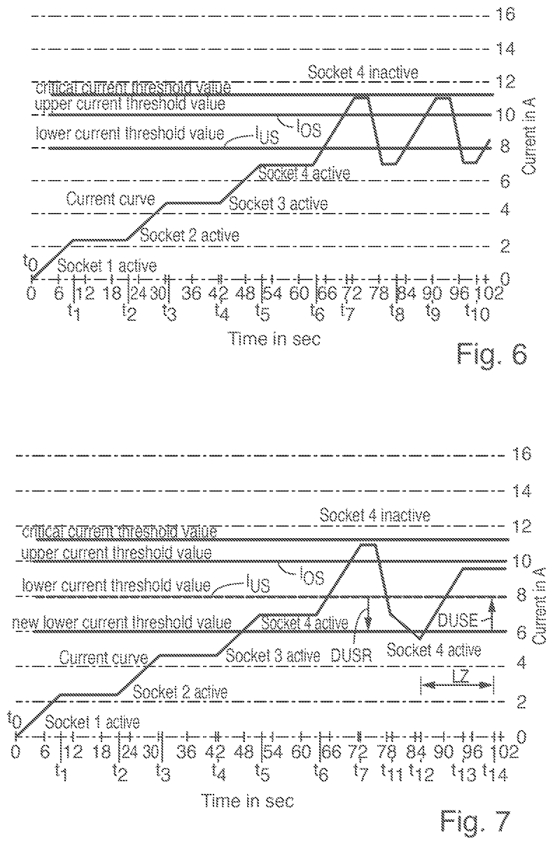

FIG. 6 shows a charging sequence, modified in relation to FIG. 5, by the charging control unit 1. The course of the current curve for the current, which is provided by the energy source for the charging operations and is received by the charging control unit 1 at the input connection 1E, corresponds to that of FIG. 5 up to the time t₆ at which the fourth charging operation is activated at the fourth output connection (socket 4), with the result that reference can be made to the above explanations of FIG. 5 in this respect. However, the current of the energy supply signal EVS, as provided by the energy source, now increases above the upper current threshold value IOS before it remains constant again at the time t₇.

This exceeding of the upper current threshold value IOS is detected by the charging control unit 1 as an undesirably high current load, which is why it deactivates the fourth charging operation at the fourth output connection (socket 4) again. The current of the input-side energy supply signal EVS then falls again to the previous current value for the first to third charging operations below the lower current threshold value IUS. As a result, the charging control unit 1 reactivates the fourth charging operation at a corresponding time t₈, as a result of which the relevant current curve rises again above the upper current threshold value IOS at a time t₉. The charging control unit 1 then deactivates the fourth charging operation again, with the result that the input-side charging current falls below the lower current threshold value IUS again and the charging control unit 1 activates the fourth charging operation again periodically at a time t₁₀. Deactivating the charging operation which was respectively activated last when the upper current threshold value IOS is exceeded by the current curve of the input current prevents the input-side charging current from exceeding a predefined critical current threshold value.

FIG. 7 illustrates a further modification of the charging sequence for a correspondingly modified design of the charging control unit 1. The aim of this design is to avoid the aforementioned periodic activation and deactivation of the respective last charging operation, the fourth charging operation at the fourth output connection (socket 4) in the example of FIG. 6. For this purpose, the charging control unit 1 is configured in this implementation to reduce the lower current threshold value IUS by a predefinable current reduction increment DUSR if the current provided by the energy source and/or the current provided by the charging control unit 1 at the relevant output connection 1A1, . . . , 1An exceeds the upper current threshold value IOS.

The charging sequence of FIG. 7 initially corresponds to the charging sequence of FIG. 6 up to the time t₇ when the upper current threshold value IOS is exceeded by the current curve of the current supplied to the input side of the charging control unit 1, as explained above. Now, however, due to the upper current threshold value IOS being exceeded by the said current curve, the charging control unit 1 reduces the lower current threshold value IUS by the predefined current reduction increment DUSR to a correspondingly lower, new lower current threshold value. As a result, the current of the energy supply signal EVS does not initially fall below the now reduced new lower current threshold value IUS, but remains above it, after deactivating the fourth charging operation at a time t₁₁.

As the input-side current of the charging control unit 1 is thus still above the present lower current threshold value IUS, the charging control unit 1 initially does not reactivate the fourth charging operation. Only when the current of the energy supply signal EVS has fallen below the present, reduced lower current threshold value IUS at a time t₁₂, for example because the first to third charging operations no longer consume as much charging current overall, does the charging control unit 1 activate the fourth charging operation at the fourth output connection (socket 4) again. As a result, the current curve of the input current increases again, but now remains constantly below the upper current threshold value IOS from a time t₁₃. This hysteresis-like adjustment of the lower current threshold value IUS means that the charging control unit 1 thus avoids the periodic activation and deactivation of the respective last charging operation, as is the case for the fourth charging operation in the example of FIG. 6.

The current reduction increment DUSR can be predefined to a value suitable for the application, usually to a value between 1 A and 5 A, in particular between at least 2 A and at most 4 A.

In advantageous examples, the charging control unit 1 is further configured to raise the lower current threshold value IUS, previously reduced by the predefinable current reduction increment DUSR, by a predefinable current increase increment DUSE if, for the same charging configuration, the current provided by the energy source and/or the current provided by the charging control unit 1 at the relevant output connection 1A1, . . . , 1An does not exceed the upper current threshold value IOS during a predefinable charging monitoring time LZ. This allows the previously reduced lower current threshold value IUS to be raised again at an appropriate time, thus preventing the lower current threshold value IUS from remaining permanently reduced. The example of FIG. 7 relates to such an additional design of the charging control unit 1. As illustrated in FIG. 7, the charging control unit 1 raises the previously reduced lower current threshold value IUS at a time t₁₄ by the predefined current increase increment DUSE if the predefined charging monitoring time LZ has elapsed at this time t₁₄ and the current curve of the current of the energy supply signal EVS has not exceeded the upper current threshold value IOS during this charging monitoring time LZ.

The current increase increment DUSE can be predefined to a value suitable for the respective application, in particular between 1 A and 5 A, and in many cases between at least 2 A and at most 4 A. The current increase increment DUSE can be predefined to the same value as the current reduction increment DUSR or to a value differing therefrom, depending on the requirements.

The functionalities explained above with regard to carrying out the charging operations in the sequences according to FIGS. 5 to 7 use the current of the energy supply signal EVS, as is present and measured on the input side of the charging control unit 1, as the relevant current criterion. In corresponding modified examples, the same functionalities of the charging control unit 1 result from using the output currents flowing on the output side of the output connection(s) 1A1, . . . , 1An and measured as in the example of FIG. 2. The current curve for the current of the energy supply signal EVS, as provided by the energy source, is then replaced by the charging current provided by the charging control unit 1 at the respective output connection 1A1, . . . , 1An and measured there. In further modified examples, both the input-side current provided by the energy source with the energy supply signal EVS and the charging current at the respective output connection 1A1, . . . , 1An are taken into account in combination for these functionalities of the charging control unit 1 which are explained in connection with FIGS. 5 to 7.

It is understood that the relevant current threshold values, such as the lower current threshold value IUS and the upper current threshold value IOS, are set to suitably modified values, depending on whether only the current of the energy supply signal EVS or only the output-side charging currents at the output connections 1A1, . . . , 1An or both the input-side current and the output-side currents is/are used for the evaluation.

In particular, for the case of the output-side current detection, provision may be made for the current increase increment DUSE at the relevant output connection 1A1, . . . , 1An to be selected according to the detected current provided at this output connection, i.e. a separate current increase increment DUSE1, . . . , DUSEn can be individually provided for each output connection 1A1, . . . , 1An, wherein these current increase increments DUSE1, . . . DUSEn can assume different values independently of each other. In the same way, the assignment of a separate lower current threshold value IUS1, . . . , IUSn can be provided in this case for each output connection 1A1, . . . , 1An, which threshold values can assume different values independently of each other. If required, a similar process can also be provided for the upper current threshold value IOS, i.e. an individual assignment of a separate upper current threshold value IOS1, . . . , IOSn to the respective output connection 1A1, . . . , 1An.

It should be mentioned at this point that the respective above-mentioned reduction or re-raising of a relevant current threshold value, depending on the requirements and application, entails a correlated appropriate reduction or re-raising of the other current threshold value(s), if any, as a person skilled in the art understands.

In advantageous examples, the battery charging control device with its charging control unit 1 is designed to adapt the charging behaviour for the coupled charger arrangement to a limited performance capacity of the energy source. This may be expedient in particular for cases where the power output capacity of the energy source is subject to temporal fluctuations or is limited for other reasons in certain periods. This applies, for example, to energy sources in the form of generators, fuel cells, photovoltaic systems and wind turbines.

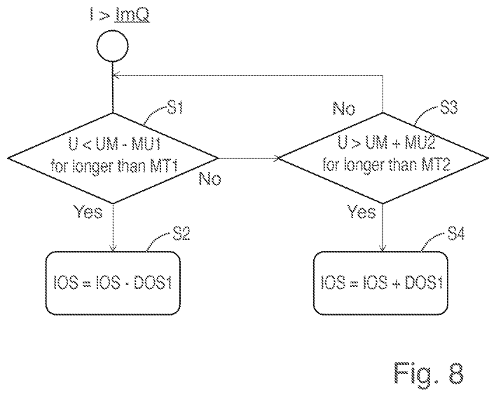

For this functionality, the charging control unit 1 is configured in advantageous examples to detect when the voltage of the energy supply signal EVS undershoots a predefinable minimum voltage setpoint UM by a predefinable undershoot amount MU1 for a predefinable minimum undershoot period MT1 and to then lower the upper current threshold value IOS by a predefinable current lowering increment DOS1. This design of the charging control unit is illustrated in the left-hand part of the flowchart of FIG. 8. Depending on the application, the minimum voltage setpoint UM and the undershoot amount MU1 as well as the minimum undershoot period MT1 are each predefined to suitable values, e.g. the minimum voltage setpoint UM to a value between 206 V and 208 V, in particular 207 V, and/or the undershoot amount MU1 to a value between 1 V and 2 V and/or the minimum undershoot period MT1 to a value between 9 ms and 11 ms, in particular 10 ms. Furthermore, the current lowering increment DOS1 is predefined, for example, to a value between 1 A and 4 A, in particular to 2 A or 2.5 A. These predefined values are especially suitable for an energy supply signal EVS with a nominal voltage of 230 V, for which a minimum setpoint of the voltage of 207 V is obtained with the usual permissible tolerance of 10%.

Furthermore, for this functionality, the charging control unit 1 is configured in advantageous examples to detect when the voltage of the energy supply signal EVS exceeds a or the predefinable minimum voltage setpoint UM by a predefinable exceedance amount MU2 for a predefinable minimum exceedance period MT2 and to then raise the upper current threshold value IOS by a predefinable current raising increment DOS2. This design of the charging control unit 1 is illustrated in the right-hand part of the flowchart of FIG. 8. In this case, the minimum voltage setpoint UM in corresponding implementations can be predefined to a value between 206 V and 208 V, in particular 207 V, and/or the exceedance amount MU2 can be predefined to a value between 1 V and 2 V and/or the minimum exceedance period MT2 can be predefined to a value between 9 ms and 11 ms, in particular 10 ms, and/or the current raising increment DOS2 can be predefined to a value between 1 A and 4 A, in particular 2 A.

Overall, the charging control unit in these examples thus fulfils the following functionality illustrated in FIG. 8 as a flowchart. First, the charging control unit 1 continuously monitors whether the current I of the energy supply signal EVS becomes greater than a predefined maximum current limit value ImQ of the energy source, wherein this limit value is typically between 10 A and 32 A, for example approx. 14 A to 15 A for a permissible continuous load of 16 A. If it is detected that the current flow becomes too high, a check is carried out in a query step S1 to determine whether a supply voltage U of the energy source breaks down. For this purpose, it is queried whether the voltage U is lower than the minimum voltage setpoint UM by more than the undershoot amount MU1 for longer than the minimum undershoot period MT1. If this is the case, this is considered a voltage dip, and, in a subsequent current reduction step S2, the upper current threshold value IOS is lowered by the predefined current lowering increment DOS1 in order to counteract the voltage dip and provide a power adjustment.

If, on the other hand, it is detected in query step S1 that there is no voltage dip, a subsequent query step S3 checks whether the voltage U from the energy source is greater than the minimum voltage setpoint UM by the exceedance amount MU2 for longer than the minimum exceedance period MT2. If this is the case, it is considered that the upper current threshold value IOS can be raised again. For this purpose, in a subsequent current raising step S4, the upper current threshold value IOS is raised by the predefined current raising increment DOS2. If query step S3 detects that the voltage U does not meet the query condition, it is considered that the upper current threshold value IOS cannot yet be raised again and there is a return to the start of the query cycle.

With this measure, the battery charging control device with its charging control unit thus allows an optimal power adjustment of the respective active charging operations for the coupled charger arrangement to the present performance capacity of the energy source or more precisely to the charging power that can be supplied by the energy supply signal EVS.

In a manner not explicitly shown, in addition to the above-mentioned functionalities, the charging control unit 1 may have charging prioritization information in order to make the activation of a respective charging operation dependent on this charging prioritization information. In this case, the charging prioritization information may comprise priority information with regard to the output connections 1A1, . . . , 1An and/or priority information with regard to the charging ports and/or priority information with regard to the states of charge of the battery units to be charged and/or priority information with regard to charging specifications for the respective charging port and/or for the respective battery unit to be charged. This measure can be used to further optimize the charging operations as needed to meet the respective requirements.

As is clear from the above explanations, the charging control unit 1 thus forms, in the battery charging control device according to the present subject matter, a power distribution unit which in an optimized manner retrieves and transmits as much power as possible from the electrical energy source for the purpose of charging coupled battery units and in the process is able to divide the charging power according to demand and in an optimized manner among the preferably multiple, in particular electrically parallel, output connections 1A1, . . . , 1An and consequently the coupled chargers with their associated charging ports. The explained battery charging control device according to the present subject matter is capable of carrying out the battery charging control method according to the present subject matter.

As the examples shown and the further examples explained above make clear, the present subject matter advantageously provides a battery charging control device and a battery charging control method that can be carried out by the latter, with which charging operations of rechargeable battery units using electrical energy from an electrical energy source can be controlled in an optimized manner, in particular with regard to optimal power delivery and power distribution at all times for preferably a plurality of simultaneously activated charging operations.

The foregoing disclosure has been set forth merely to illustrate the present subject matter and is not intended to be limiting. Since modifications of the disclosed examples incorporating the spirit and substance of the present subject matter may occur to persons skilled in the art, the present subject matter should be construed to include everything within the scope of the appended claims and equivalents thereof.

What is claimed is:

1. A battery charging control device for controlling charging operations of rechargeable battery units, for which electrical energy is provided by an electrical energy source, comprising:
a charging control unit having an input connection capable of being coupled to the energy source for supplying an energy supply signal, and an output connection configuration with one or more output connections for coupling a charger arrangement with comprises one or more chargers, each having one or more charging ports for the rechargeable battery units, wherein
the charging control unit is configured to detect a maximum current load state of an electrical current overload protection system of the energy source and, when the maximum current load state of the current overload protection system is detected, to control current carried by the energy supply signal from the energy source via the current overload protection system to ensure that the detected maximum current load state of the current overload protection system is complied with, or
the charging control unit is configured to
monitor at least one of a current provided by the energy source at the input connection or a current provided at a respective output connection and to enable activation of a charging operation at a respective charging port when the current provided by the energy source and/or the current provided by the charging control unit at the relevant output connection does not exceed an associated predefinable lower current threshold value, or
reduce a current provided for a charging operation at a respective charging port when the current provided by the energy source and/or the current provided by the charging control unit at the relevant output connection exceeds an associated predefinable upper current threshold value.

2. The battery charging control device according to claim 1, further wherein
the charging control unit is configured
to determine a signal strength of at least one of a frequency component of an AC voltage and/or an alternating current of the energy supply signal from the energy source in a predefinable monitoring frequency range and
to detect a presence of the maximum current load state of the current overload protection system if the signal strength is above a normal signal strength by a predefinable amount, wherein
the monitoring frequency range is above 10 kHz and/or below 150 kHz.

3. The battery charging control device according to claim 1, further wherein
the charging control unit is configured to enable one or more charging operations only until the maximum current load state of the current overload protection system is reached.

4. The battery charging control device according to claim 1, further wherein
the charging control unit is configured to reduce the lower current threshold value by a predefinable current reduction increment if the current provided by the energy source or
the current provided by the charging control unit at the relevant output connection exceeds the upper current threshold value.

5. The battery charging control device according to claim 4, further wherein
the current reduction increment is predefinable to a value between 1 A and 5 A.

6. The battery charging control device according to claim 4, further wherein
the current reduction increment is predefinable to a value between at least 2 A and at most 4 A.

7. The battery charging control device according to claim 4, further wherein
the charging control unit is configured to raise the lower current threshold value, previously reduced by the predefinable current reduction increment, by a predefinable current increase increment if the current provided by the energy source or
the current provided by the charging control unit at the relevant output connection does not exceed the upper current threshold value during a predefinable charging monitoring time.

8. The battery charging control device according to claim 7, further wherein
the current increase increment is predefinable to a value between 1 A and 5 A, or to the same value as the current reduction increment.

9. The battery charging control device according to claim 7, further wherein
the current increase increment is predefinable to a value between at least 2 A and at most 4 A, and/or to the same value as the current reduction increment.

10. The battery charging control device according to claim 1, further wherein
the charging control unit is configured to detect when the voltage of the energy supply signal undershoots a predefinable minimum voltage setpoint by a predefinable undershoot amount for a predefinable minimum undershoot period and to then lower the upper current threshold value by a predefinable current lowering increment.

11. The battery charging control device according to claim 10, further wherein one or more of:
the minimum voltage setpoint is predefinable to a value between 206 V and 208 V, or
the undershoot amount is predefinable to a value between 1 V and 2 V or the minimum undershoot period is predefinable to a value between 9 ms and 11 ms, or
the current lowering increment is predefinable to a value between 1 A and 4 A.

12. The battery charging control device according to claim 11, further wherein one or more of:
the minimum voltage setpoint is predefinable to a value of 207 V, or
the minimum undershoot period is predefinable to a value of 10 ms, or
the current lowering increment is predefinable to a value of 2 A.

13. The battery charging control device according to claim 1, further wherein
the charging control unit is configured to detect when the voltage of the energy supply signal exceeds a predefinable minimum voltage setpoint by a predefinable exceedance amount for a predefinable minimum exceedance period and to then raise the upper current threshold value by a predefinable current raising increment.

14. The battery charging control device according to claim 13, further wherein one or more of:
the minimum voltage setpoint is predefinable to a value between 206 V and 208 V, or
the exceedance amount is predefinable to a value between 1 V and 2 V or the minimum exceedance period is predefinable to a value between 9 ms and 11 ms, or
the current raising increment is predefinable to a value between 1 A and 4 A.

15. The battery charging control device according to claim 14, further wherein one or more of:
the minimum voltage setpoint is predefinable to a value of 207 V, or
the minimum exceedance period is predefinable to a value of 10 ms, or
the current raising increment is predefinable to a value of 2 A.

16. The battery charging control device according to claim 1, further wherein
the charging control unit has charging prioritization information, on the basis of which it initiates activation of a respective charging operation, wherein
the charging prioritization information comprises an output connection priority information or
a charging port priority information or
a state of charge priority information or
a charging specification priority information.

17. A battery charging control method for controlling charging operations of rechargeable battery units, for which electrical energy is provided by an electrical energy source, comprising:
receiving an energy supply signal from the energy source at an input connection of a charging control unit which, via an output connection configuration with one or more parallel output connections, feeds charging current to a charger arrangement comprising one or more chargers each having one or more charging ports for the rechargeable battery units; and
detecting a maximum current load state of an electrical current overload protection system of the energy source and, when the maximum current load state of the current overload protection system is detected, limiting the current carried by the energy supply signal from the energy source via the current overload protection system to ensure that the detected maximum current load state of the current overload protection system is complied with; or
at least one of
monitoring the current provided by the energy source at the input connection of the charging control unit and
monitoring a current provided at a respective output connection of the charging control unit and enabling activation of a charging operation at a respective charging port only if at least one of
the current provided by the energy source or the current provided by the charging control unit at the relevant output connection does not exceed an associated predefinable lower current threshold value, or
a charging operation at a respective charging port when the current provided by the energy source is deactivated when the current provided by the charging control unit at the relevant output connection exceeds an associated predefinable upper current threshold value.
